(19) United States
(12) Patent Application Publication
(10) Pub. No.: US 2024/0356992 A1
(43) Pub. Date: Oct. 24, 2024

(54) SYSTEMS AND METHODS FOR SHARING INTERACTABLE ELEMENTS FROM SHARED SCREENS

(71) Applicant: Meta Platforms Technologies, LLC, Menlo Park, CA (US)

(72) Inventors: Maher Afif Saba, Seattle, WA (US); Aleksey Sergeyevich Fadeev, Issaquah, WA (US)

(21) Appl. No.: 18/151,829

(22) Filed: Jan. 9, 2023

(51) Int. Cl. H04L 65/1089; G06F 3/04842; G06F 3/14

(52) U.S. Cl. CPC H04L 65/1089; G06F 3/04842; G06F 3/1454

(57) ABSTRACT

A computer-implemented method for sharing interactable elements from shared screens may include (i) identifying a call in which a user is sharing a screen of a computing device with at least one additional user who is participating in the call via an additional computing device, (ii) detecting an interactable element within text that is being shared in the shared screen that is interactable via the computing device but not via an instance of the shared screen on the additional computing device, and (iii) in response to detecting the interactable element, transmitting the interactable element to the additional computing device to enable the additional user to interact with the interactable element via the additional computing device. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for sharing interactable elements from shared screens.

FIG. 2 is a flow diagram of an exemplary method for sharing interactable elements from shared screens.

FIG. 3 is an illustration of an exemplary system for sharing interactable elements from shared screens via multiple data channels.

FIG. 4 is an illustration of sharing a link from a shared screen via a notification overlay.

FIG. 5 is an illustration of sharing a link from a shared screen via a list of links.

FIG. 6 is an illustration of sharing a link from a shared screen via a link embedded in the shared screen itself.

FIG. 7 is an illustration of an exemplary shared interactable element from a shared screen in a virtual reality environment.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Sharing links and other text within a video call is not easy or intuitive. For example, users often share a screen with a document that has links in it, prompting the receiving users to intuitively attempt to click on the links, which fails because they are clicking on a video feed and not an actual link. The present disclosure is generally directed to systems and methods for sharing interactable elements from shared screens. In some embodiments, the systems described herein may detect a link in the contents of a shared screen and may transmit data about the link to users in the call for display, such as in an overlay, in a list of links, or inline where the link is visible in the video. In some examples, a user may manually specify a link to share, while in other examples, the systems described herein may automatically detect and share links. In one embodiment, the systems described herein may enable users to share other interactable elements in video calls. For example, if a user is sharing a text document, the systems described herein may transmit the text of the document so that other users can search, copy, and/or otherwise interact with the text. Enabling the sharing of links and text in this way may make calls more productive and intuitive and less frustrating for users.

In some embodiments, the systems described herein may improve the functioning of a computing device by improving the ability of the computing device to share data such as links during conference calls. Additionally, the systems described herein may improve the fields of audio conferencing, video conferencing, and/or virtual conferencing by sharing links and/or other interactable elements in an intuitive manner.

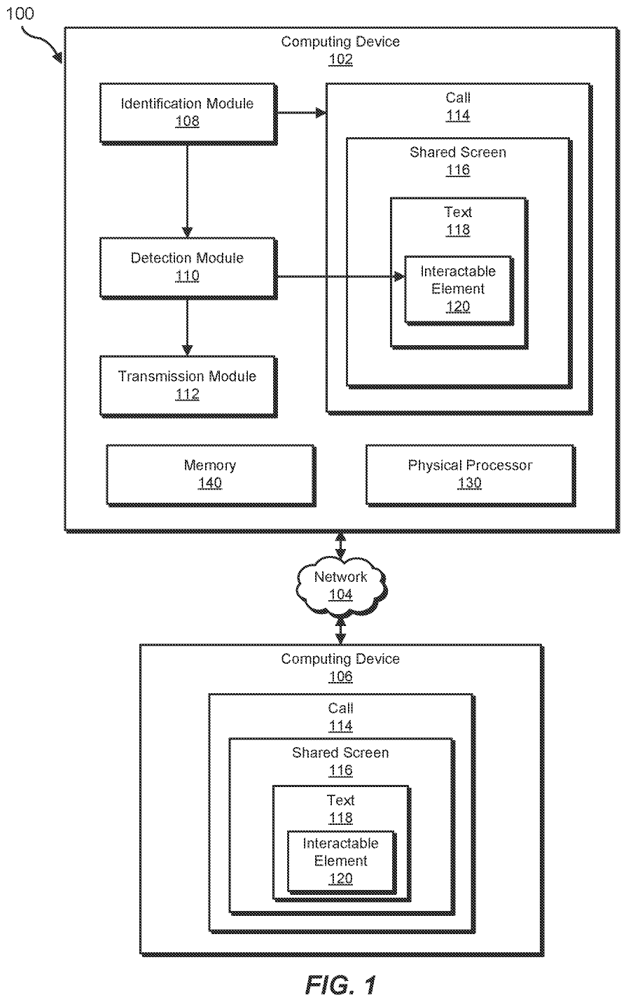

In some embodiments, the systems described herein may transmit data about interactable elements in a screenshare between two endpoint devices. FIG. 1 is a block diagram of an exemplary system 100 for sharing links during conference calls. In one embodiment, and as will be described in greater detail below, a computing device 102 may be configured with an identification module 108 that may identify a call 114 in which a user is sharing a shared screen 116 of a computing device with at least one additional user who is participating in call 114 via a computing device 106. At some point during call 114, a detection module 110 on computing device 102 may detect an interactable element 120 within text 118 that is being shared in shared screen 116 and that is interactable via computing device 102 but not via an instance of shared screen 116 on computing device 106. In response to detecting interactable element 120, a transmission module 112 on computing device 102 may transmit (e.g., via a network 104) interactable element 120 to computing device 106 to enable the additional user to interact with interactable element 120 via computing device 106.

Computing devices 102 and 106 generally represent any type or form of computing device capable of reading computer-executable instructions. For example, computing device 102 may represent an endpoint computing device and/or personal computing device. Examples of computing device 102 may include, without limitation, a laptop, a desktop, a wearable device, a smart device, an artificial reality device, a personal digital assistant (PDA), etc.

Call 114 generally refers to any real-time communication between two or more users via two or more computing devices that includes one or more of audio, video, and/or live text communication channels. In some embodiments, call 114 may be a video conference call. In some examples, call 114 may be facilitated and/or hosted by a conference application that enables users to share screens.

Shared screen 116 generally represents any live video stream of at least one window of a user interface of a computing device. In some examples, a shared screen may transmit the entire visible area of a display surface of a computing device while in other examples, a shared screen may only transmit a single window or application at a time. For example, a user may share a screen of a document, a web browser, a file system browser, and/or a media player. In one embodiment, any user on a call where a screen is being shared may choose to view the shared screen. However, by default a shared screen may only transmit pixels that represent the display of the originating device, rather than any functionality present on that device. For example, a link in a web page that is clickable in the web browser of the device transmitting the shared screen may not be clickable by users viewing the shared screen on other devices, absent steps performed by the systems described herein.

Text 118 generally refers to any human-readable language, programming language, and/or other textual characters visible within a screen share. In some examples, text 118 may include text within a document in a document editor that is being shared during a call. In another example, text 118 may include text on a web page within a web browser that is being shared during a call. Additionally or alternatively, text 118 may include code in an integrated development environment (IDE) that is being shared during a call.

Interactable element 120 generally represents any element that includes text or is embedded within text and that can be interacted with by a user via a computing device. For example, an interactable element may include a text link that can be clicked or tapped to open a specified uniform resource locator (URL) in a web browser. In one example, the interactable element may be the URL itself, while in other examples the interactable element may be different text (e.g., “click here to learn more”) that opens the URL when clicked or tapped. In some examples, an interactable element may be selectable text that can be copied while selected. For example, a sentence within a text editor or a block of code within an IDE may be an interactable element that a user viewing the screen share on another device may wish to copy to paste into another document. Additionally or alternatively, selectable text may be interactable in other ways, such as being searchable and/or being available for other application functionality (e.g., spellcheck, dictionary lookup, etc.). In one example, the systems described herein may enable a user to highlight, underscore, and/or save selectable text (e.g., as an anchor or bookmark).

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

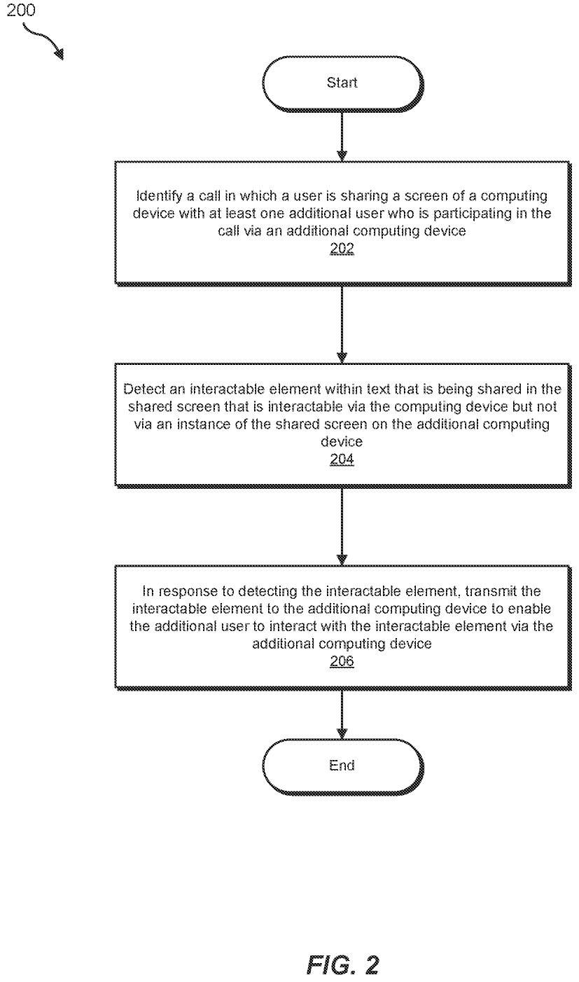

FIG. 2 is a flow diagram of an exemplary method 200 for sharing interactable elements from shared screens. In some examples, at step 202, the systems described herein may identify a call in which a user is sharing a screen of a computing device with at least one additional user who is participating in the call via an additional computing device.

The systems described herein may identify a call in which a user is sharing a screen in a variety of ways. In some embodiments, as soon as a user begins sharing a screen, the systems described herein may begin monitoring the shared screen for interactable elements. Additionally or alternatively, the systems described herein may include a toggle that enables a user to choose whether or not to automatically share interactable elements from a shared screen.

At step 204, the systems described herein may detect an interactable element within text that is being shared in the shared screen that is interactable via the computing device but not via an instance of the shared screen on the additional computing device.

The systems described herein may detect the interactable element in a variety of ways. In some embodiments, the systems described herein may automatically detect the interactable element in response to detecting text in the shared screen. For example, the systems described herein may treat all text as an interactable element (e.g., because users often expect text to be selectable). Additionally or alternatively, the systems described herein may automatically parse shared documents for links and/or may automatically detect links in text. In some embodiments, the systems described herein may detect the interactable element within the text by receiving user input from the user identifying the interactable element. For example, a user may click, right-click, tap, select, highlight, or otherwise interact with an interactable element and the systems described herein may receive this as input. In some embodiments, a user may select an interactable element and the systems described herein may display a menu option (e.g., in the user interface of the call application) that, if selected, shares the interactable element with one or more other users on the call. In some examples, all shared elements may be shared with all users on a call, while in other examples, the systems described herein may enable a user to share interactable elements with some users on a call but not others.

Additionally or alternatively, the systems described herein may detect the interactable element automatically. For example, the systems described herein may search the text for embedded hyperlinks. In one embodiment, the systems described herein may parse the text for patterns characteristic of a URL, such as the characters “http” and/or certain patterns of punctuation such as periods and forward slashes. In one example, the systems described herein may identify an interactable element that includes an email address based at least in part on the format of the text including alphanumeric characters followed by the “@” symbol and a pattern indicative of a domain name.

In some embodiments, the interactable element may be interactable on the original screen being shared (e.g., a text document, a webpage, etc.) but not via an instance of the shared screen on another user's computer. The phrase “instance of the shared screen” generally refers to any video reproduction of the original shared screen on another computing device besides the originating device from which the screen is being shared.

At step 206, in response to detecting the interactable element, the systems described herein may transmit the interactable element to the additional computing device to enable the additional user to interact with the interactable element via the additional computing device.

The systems described herein may transmit the interactable element to the additional computing device in a variety of ways. In some embodiments, the systems described herein may transmit the interactable element in a separate message and/or channel from a message and/or channel that contains the data for the shared screen. In one embodiment, the systems described herein may encode the interactable element in a supplemental data channel that is separate from a screen-sharing data channel that transmits the shared screen and then may transmit the interactable element to the additional computing device via the supplemental data channel. The term data channel may generally refer to any transmission route used for passing a specified type of data between two or more computing devices. For example, a video data channel may transmit video data between a computing device that is sharing a screen and a computing device displaying an instance of a shared screen. In another example, a media data channel may transmit chat text and reaction icons between computing devices participating in a conference call that includes a text chat. In some embodiments, a control channel may send and/or receive commands and/or operations while a data channel may send and/or receive corresponding data to be operated upon.

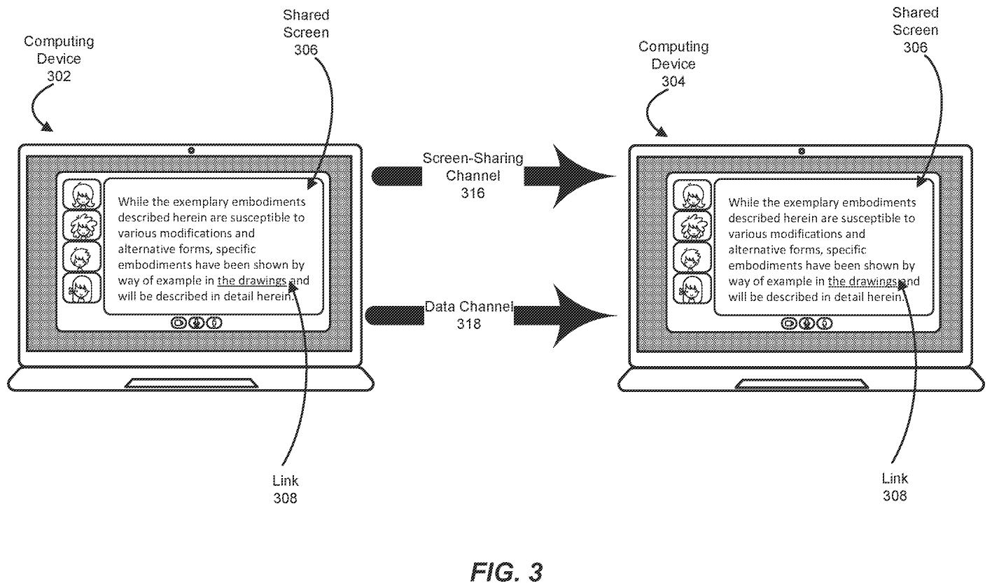

In one example, as illustrated in FIG. 3, a computing device 302 may be sharing a shared screen 306 that includes a link 308 that is an interactable element that hyperlinks to a webpage. In one embodiment, the systems described herein may transmit the data for shared screen 306 to a computing device 304 via a screen-sharing channel 316 and may transmit the data for link 308 to computing device 304 via a data channel 318. In some examples, computing device 304 may then enable a user to interact with link 308 (e.g., click the hyperlink to open the linked webpage) within a display of shared screen 306 on computing device 304. In this example, screen-sharing channel 316 may transmit only video data associated with shared screen 306 while data channel 318 may transmit data regarding interactable elements. In some embodiments, computing device 302 may send other data relevant to the call (e.g., participant video and audio data, text chat data, etc.) to computing device 304 via one or more additional data channels (not depicted in FIG. 3).

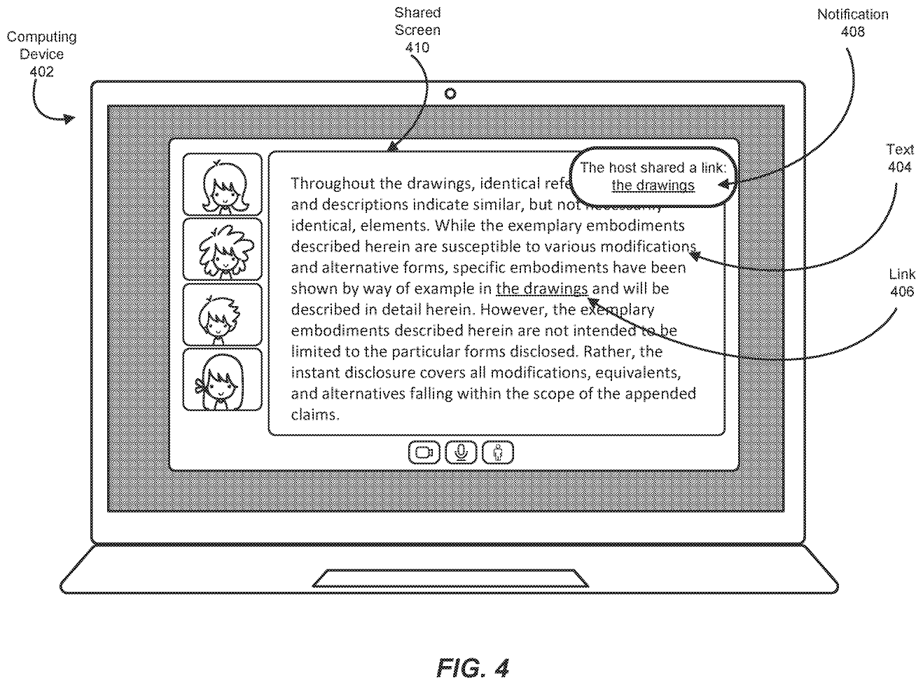

The systems described herein may enable the additional user to interact with the interactable element in a variety of ways. In some examples, the systems described herein may display the interactable element in an overlay over the shared screen on the additional computing device. The term overlay may generally refer to any graphical element that partially or entirely obscures other preexisting graphical elements, such as a pop-up notification that partially obscures the contents of a shared screen. For example, as illustrated in FIG. 4, a computing device 402 may be participating in a conference call in which a user is sharing a shared screen 410 that contains a link 406 within text 404 that is not clickable on computing device 402 due to originating on another computing device and only being visible as part of a live video feed of shared screen 410 on computing device 402. In one example, the systems described herein may be installed on the originating computing device and may parse text 404 for link 406 and transmit data about link 406 (e.g., the URL to which link 406 points) to computing device 402 and the systems described herein as installed on computing device 402 may display a notification 408 as an overlay that includes an interactable version of link 406 that can be clicked on at computing device 402 to open the appropriate URL.

In some embodiments, the systems described herein may display notification 408 in response to a trigger, such as the user of the originating computing device sharing link 406, the user of computing device 402 attempting to click link 406 on shared screen 410, and/or some other trigger. In some examples, notification 408 may be a temporary overlay that fades after a preset time (e.g., 5 seconds, 10 seconds, etc.) while in other examples, notification 408 may remain visible until dismissed by the user of computing device 402 and/or some other trigger occurs (such as being displaced by a different notification).

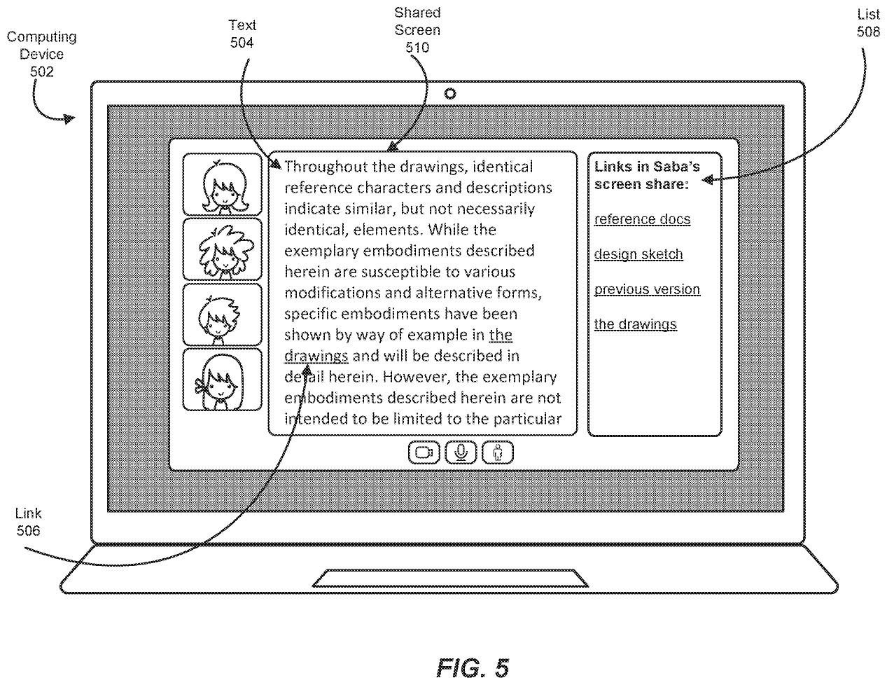

In another embodiment, the systems described herein may enable the additional user to interact with the interactable element by displaying a list of interactable elements from the shared screen in a user interface for the call on the additional computing device. For example, as illustrated in FIG. 5, a computing device 502 may be participating in a conference call in which a user on another computing device is sharing a shared screen 510 that includes a document with text 504 that contains a link 506 and/or additional links. In some embodiments, the systems described herein may parse text 504 on the originating computing device for interactable elements, generate a list of links that includes link 506, and transmit this list to computing device 502 for display. In some examples, the systems described herein on computing device 502 may then display a list 508 that includes all of the links in text 504 and/or all of the links currently visible in shared screen 510 (which may be a subset of all of the links in text 504 if text 504 is a document that is larger than the display size of shared screen 510) in an interactable form.

In one example, the systems described herein may enable a user of computing device 502 to click on any of the links within list 508. In some embodiments, links in list 508 may be displayed using the display text from text 504. Additionally or alternatively, links in list 508 may be displayed as URLs. In some examples, the systems described herein may display list 508 in response to a request from the user of computing device 502. In other examples, the systems described herein may display list 508 in response to a request from the user of the originating computing device that is sharing shared screen 510.

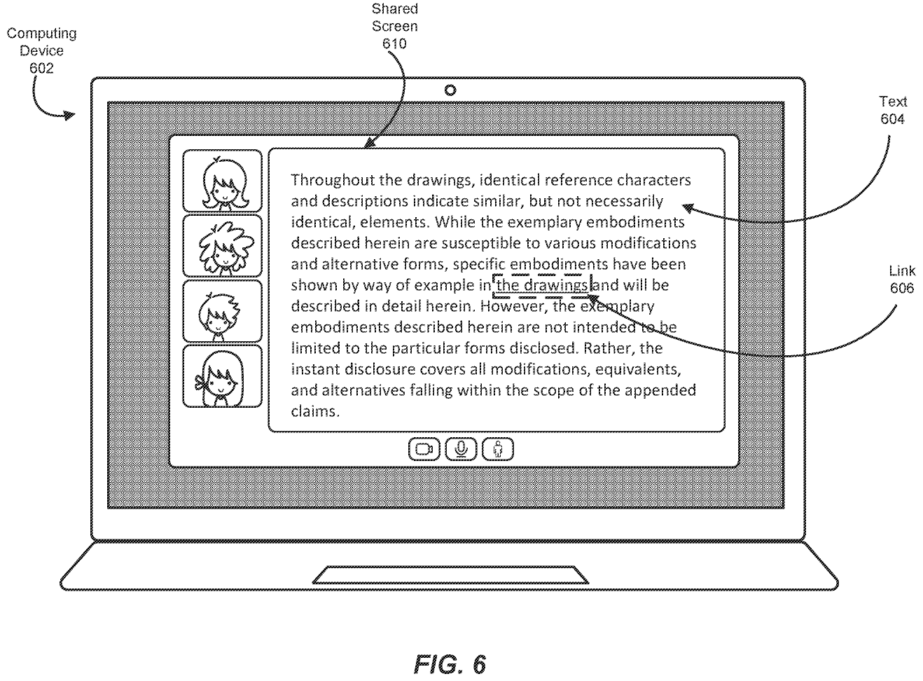

Additionally or alternatively, systems described herein may enable the additional user to interact with the interactable element by transforming, via pixel mapping, the text displayed within the shared screen on the additional computing device into the interactable element. The term pixel mapping may generally refer to any process that identifies an area of pixels in a video and causes an effect when those pixels are interacted with by a user (e.g., clicked or tapped), effectively mapping the effect onto the pixels of an otherwise non-interactable video. For example, as illustrated in FIG. 6, the systems described herein may enable a user of computing device 602 to click on a link 606 directly within shared screen 610 by mapping the location of link 606 within text 604 and shared screen 610 such that, when the user of computing device 602 clicks on shared screen 610 in the vicinity of link 606, the systems described herein may identify link 606 and open the corresponding URL. In one embodiment, the systems described herein may map the location of link 606 by recording the arrangement of pixels (e.g., color, shape, relative position, etc.) that make up link 606 and tracking this arrangement of pixels within the shared screen (e.g., as a user scrolls the document, changing the location of link 606). In some embodiments, the systems described herein may map the exact pixels that make up link 606, while in other embodiments, the systems described herein may define a shape around link 606 (e.g., a rectangle) and may open the corresponding URL when any area within the shape is interacted with. In some examples, the systems described herein may track multiple areas of pixels and map different effects onto different areas (e.g., opening the corresponding URLs when various links are clicked). In some embodiments, the systems described herein may automatically make all links and/or other interactable elements within text 604 interactable in this way.

Though described in terms of links in connection with FIGS. 4-6, the systems described herein may enable interaction with various types of interactable elements in various types of user interfaces. For example, the systems described herein may use pixel mapping to enable a user to select a section of text 604 within shared screen 610. Similarly, the systems described herein may enable a user who is sharing their screen to highlight a selection of text to be sent to other users as a notification or within a list of shared text.

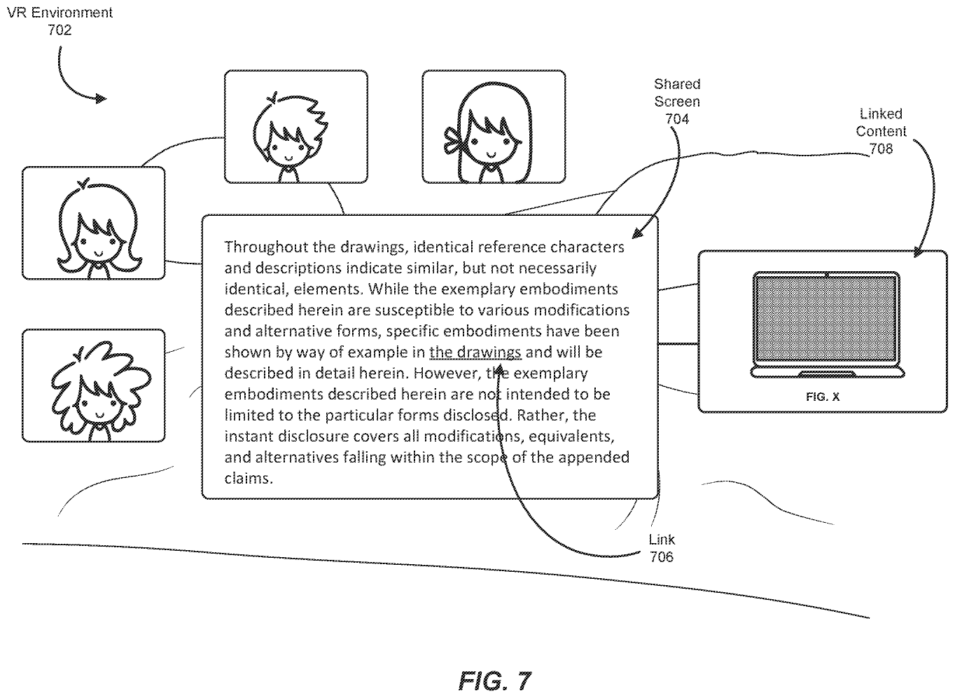

In some embodiments, the systems described herein may enable a user to interact with interactable elements shared as part of a virtual reality (VR) conference call. In one embodiment, the systems described herein may activate the interactable element within a VR environment displayed by the additional computing device. For example, as illustrated in FIG. 7, a user may be participating in a conference call while in a VR environment 702. In one example, the VR environment may include various virtual screens that show video feeds of other participants in the conference call as well as a virtual screen that displays a shared screen 704. In some examples, the systems described herein may detect a link 706 in shared screen 704 and may automatically open a new virtual screen that displays linked content 708. For example, if link 706 links to another file on an internal filesystem to which the user has access, the systems described herein may display the linked file on a virtual screen. Additionally or alternatively, the systems described herein may display linked content 708 in response to input from the user, such as the user pointing at, touching, or gesturing at link 706 in shared screen 704.

As described above, the systems and methods described herein may improve the usability of audio or video conference calls by enabling users to easily and intuitively share links and other interactive content within shared screens. Rather than having to manually extract links and post these links to a chat to be pasted into a browser, the systems described herein may enable users to send other users links as overlays or lists or may embed the links within the video stream of the shared screen via pixel mapping. By enabling users to click on links in a shared screen and open those links as if the shared screen were a document open on the user's own computing device, the systems described herein may reduce user frustration and barriers to information sharing on calls.

### EXAMPLE EMBODIMENTS

Example 1: A method for sharing interactable elements from shared screens may include (i) identifying a call in which a user is sharing a screen of a computing device with at least one additional user who is participating in the call via an additional computing device, (ii) detecting an interactable element within text that is being shared in the shared screen that is interactable via the computing device but not via an instance of the shared screen on the additional computing device, and (iii) in response to detecting the interactable element, transmitting the interactable element to the additional computing device to enable the additional user to interact with the interactable element via the additional computing device.

Example 2: The computer-implemented method of example 1, the shared screen comprises a live video stream of at least one window of a user interface of the computing device.

Example 3: The computer-implemented method of examples 1-2, wherein the interactable element comprises a uniform resource locator.

Example 4: The computer-implemented method of examples 1-3, wherein the interactable element comprises selectable text that can be copied while selected.

Example 5: The computer-implemented method of examples 1-4, where transmitting the interactable element to the additional computing device comprises encoding the interactable element in a supplemental data channel that is separate from a screen-sharing data channel that transmits the shared screen and transmitting the interactable element to the additional computing device via the supplemental data channel.

Example 6: The computer-implemented method of examples 1-5, where enabling the additional user to interact with the interactable element via the additional computing device comprises displaying the interactable element in an overlay over the shared screen on the additional computing device.

Example 7: The computer-implemented method of examples 1-6, where enabling the additional user to interact with the interactable element via the additional computing device comprises displaying a list of interactable elements from the shared screen in a user interface for the call on the additional computing device.

Example 8: The computer-implemented method of examples 1-7, where enabling the additional user to interact with the interactable element via the additional computing device comprises transforming, via pixel mapping, the text displayed within the shared screen on the additional computing device into the interactable element.

Example 9: The computer-implemented method of examples 1-8, where detecting the interactable element within the text comprises receiving user input from the user identifying the interactable element.

Example 10: The computer-implemented method of examples 1-9, where detecting the interactable element within the text comprises automatically detecting the interactable element in response to detecting the text in the shared screen.

Example 11: The computer-implemented method of examples 1-10, wherein enabling the additional user to interact with the interactable element via the additional computing device comprises activating the interactable element within a virtual reality environment displayed by the additional computing device.

Example 12: A system for sharing interactable elements from shared screens may include at least one physical processor and physical memory including computer-executable instructions that, when executed by the physical processor, cause the physical processor to (i) identify a call in which a user is sharing a screen of a computing device with at least one additional user who is participating in the call via an additional computing device, (ii) detect an interactable element within text that is being shared in the shared screen that is interactable via the computing device but not via an instance of the shared screen on the additional computing device, and (iii) in response to detecting the interactable element, transmit the interactable element to the additional computing device to enable the additional user to interact with the interactable element via the additional computing device.

Example 13: The system of example 12, where the shared screen comprises a live video stream of at least one window of a user interface of the computing device.

Example 14: The system of examples 12-13, where the interactable element comprises a uniform resource locator.

Example 15: The system of examples 12-14, where wherein the interactable element comprises selectable text that can be copied while selected.

Example 16: The system of examples 12-15, where transmitting the interactable element to the additional computing device comprises encoding the interactable element in a supplemental data channel that is separate from a screen-sharing data channel that transmits the shared screen and transmitting the interactable element to the additional computing device via the supplemental data channel.

Example 17: The system of examples 12-16, where enabling the additional user to interact with the interactable element via the additional computing device comprises displaying the interactable element in an overlay over the shared screen on the additional computing device.

Example 18: The system of examples 12-17, where enabling the additional user to interact with the interactable element via the additional computing device comprises displaying a list of interactable elements from the shared screen in a user interface for the call on the additional computing device.

Example 19: The system of examples 12-18, where enabling the additional user to interact with the interactable element via the additional computing device comprises transforming, via pixel mapping, the text displayed within the shared screen on the additional computing device into the interactable element.

Example 20: A non-transitory computer-readable medium may include one or more computer-readable instructions that, when executed by at least one processor of a computing device, cause the computing device to (i) identify a call in which a user is sharing a screen of a computing device with at least one additional user who is participating in the call via an additional computing device, (ii) detect an interactable element within text that is being shared in the shared screen that is interactable via the computing device but not via an instance of the shared screen on the additional computing device, and (iii) in response to detecting the interactable element, transmit the interactable element to the additional computing device to enable the additional user to interact with the interactable element via the additional computing device.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive screen share data to be transformed, transform the data to parse the data for interactable elements, output a result of the transformation to prepare the interactable element for transmission, use the result of the transformation to transmit the interactable element, and store the result of the transformation to display the interactable element. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying, at a computing device, a call in which a user is sharing a shared screen of the computing device with at least one additional user who is participating in the call via an additional computing device;
detecting, at the computing device, an interactable element within text that is being shared in the shared screen that is interactable via the computing device but not via an instance of the shared screen on the additional computing device; and
in response to detecting the interactable element, transmitting the interactable element from the computing device to the additional computing device to enable the at least one additional user to interact with the interactable element via a screenshare display displayed at the additional computing device.

2. The computer-implemented method of claim 1, wherein the shared screen comprises a live video stream of at least one window of a user interface of the computing device.

3. The computer-implemented method of claim 1, wherein the interactable element comprises a uniform resource locator.

4. The computer-implemented method of claim 1, wherein the interactable element comprises selectable text that can be copied while selected.

5. The computer-implemented method of claim 1, wherein transmitting the interactable element to the additional computing device comprises:
encoding the interactable element in an interactable element data channel that is separate from a screen-sharing data channel that transmits the shared screen; and
transmitting the interactable element to the additional computing device via the interactable element data channel.

6. The computer-implemented method of claim 1, wherein enabling the at least one additional user to interact with the interactable element via the additional computing device comprises displaying the interactable element in an overlay over the shared screen on the additional computing device.

7. The computer-implemented method of claim 1, wherein enabling the at least one additional user to interact with the interactable element via the additional computing device comprises displaying a list of interactable elements from the shared screen in a user interface for the call on the additional computing device.

8. The computer-implemented method of claim 1, wherein enabling the at least one additional user to interact with the interactable element via the additional computing device comprises transforming, via pixel mapping, the text displayed within the shared screen on the additional computing device into the interactable element.

9. The computer-implemented method of claim 1, wherein detecting the interactable element within the text comprises receiving user input from the user identifying the interactable element.

10. The computer-implemented method of claim 1, wherein detecting the interactable element within the text comprises automatically detecting the interactable element in response to detecting the text in the shared screen.

11. The computer-implemented method of claim 1, wherein enabling the at least one additional user to interact with the interactable element via the additional computing device comprises activating the interactable element within a virtual reality environment displayed by the additional computing device.

12. A system comprising:
at least one physical processor of a computing device; and
physical memory of the computing device comprising computer-executable instructions that, when executed by the at least one physical processor, cause the at least one physical processor to:
identify, at the computing device, a call in which a user is sharing a shared screen of the computing device with at least one additional user who is participating in the call via an additional computing device;
detect, at the computing device, an interactable element within text that is being shared in the shared screen that is interactable via the computing device but not via an instance of the shared screen on the additional computing device; and
in response to detecting the interactable element, transmit the interactable element from the computing device to the additional computing device to enable the at least one additional user to interact with the interactable element via a screenshare display displayed at the additional computing device.

13. The system of claim 12, wherein the shared screen comprises a live video stream of at least one window of a user interface of the computing device.

14. The system of claim 12, wherein the interactable element comprises a uniform resource locator.

15. The system of claim 12, wherein the interactable element comprises selectable text that can be copied while selected.

16. The system of claim 12, wherein transmitting the interactable element to the additional computing device comprises:
encoding the interactable element in an interactable element data channel that is separate from a screen-sharing data channel that transmits the shared screen; and
transmitting the interactable element to the additional computing device via the interactable element data channel.

17. The system of claim 12, wherein enabling the at least one additional user to interact with the interactable element via the additional computing device comprises displaying the interactable element in an overlay over the shared screen on the additional computing device.

18. The system of claim 12, wherein enabling the at least one additional user to interact with the interactable element via the additional computing device comprises displaying a list of interactable elements from the shared screen in a user interface for the call on the additional computing device.

19. The system of claim 12, wherein enabling the at least one additional user to interact with the interactable element via the additional computing device comprises transforming, via pixel mapping, the text displayed within the shared screen on the additional computing device into the interactable element.

20. A non-transitory computer-readable medium comprising one or more computer-readable instructions that, when executed by at least one processor of a computing device, cause the computing device to:
identify, at the computing device, a call in which a user is sharing a shared screen of the computing device with at least one additional user who is participating in the call via an additional computing device;
detect, at the computing device, an interactable element within text that is being shared in the shared screen that is interactable via the computing device but not via an instance of the shared screen on the additional computing device; and
in response to detecting the interactable element, transmit the interactable element from the computing device to the additional computing device to enable the at least one additional user to interact with the interactable element via a screenshare display displayed at the additional computing device.
